(19) United States
(12) Patent Application Publication
(10) Pub. No.: US 2005/0221064 A1
(43) Pub. Date: Oct. 6, 2005

(54) Method of manufacturing a surface decorated wall base

(76) Inventors: Jerald L. Glatz, Garrettsville, OH (US); Jodi Coburn, Waterloo (CA)

Correspondence Address: D. PETER HOCHBERG CO. L.P.A., 1940 EAST 6TH STREET, CLEVELAND, OH, 44114, US

(21) Appl. No.: 10/816,610

(22) Filed: Apr. 2, 2004

(51) Int. Cl. B41M 5/40

(52) U.S. Cl. 428/195.1

(57) ABSTRACT

A method for manufacturing a surface decorated, flexible wall base, a system for effecting the method and a wall base made using the method are presented. The decoration is applied using heat-activated ink transfer foils adhered to a flexible base layer during the extrusion process or as part of a post extrusion process.

### BACKGROUND OF THE INVENTION

1. Field of the Invention

This invention relates to the manufacture of wall or cove bases, and in particular to decorating moving flexible plastic or rubber surfaces with ink transfers from a flexible carrier. The decoration is applied using heat-activated ink transfers from foils having ink transfer layers adhered to a carrier layer, the ink transfers being applied to a flexible base layer formed during an extrusion process or as part of a post extrusion process.

2. Description of the Prior Art

Wall bases are known in the art as molding or trim applied at the base of a wall to complete the intersection of the wall and the floor. Decorative wall bases are typically fabricated from wood or other rigid workable materials such as vinyl or rubber. These wall bases decorate as well as protect the wall from scuffing and impact from feet, vacuum cleaners, wheelchairs, dollies, wheeled furniture, etc. Furthermore, the wall bases protect the edge of the carpet or flooring adjacent to the wall.

A variety of techniques have been used to apply decorations to wall and cove bases. Traditionally, designs or colors have been applied to wood wall bases by painting or staining. In the alternative, one can apply decoration by placing trim such as fabrics, paper, etc., onto the wall base. U.S. Pat. No. 1,988,236 shows a strip molding with a marginally flared groove into which an ornamental filling can be glued or attached with brads. U.S. Pat. No. 4,520,605 shows two strips whose cross sections join to form a cavity into which caulking and then molding are inserted. The molding is perforated so that the caulking fills the cavities and seeps through the molding enhancing the decoration. U.S. Pat. No. 5,213,870 shows that one may attach lustrous tape members to a desired portion of a panel for decoration. U.S. Pat. No. 5,398,469 shows a decorative molding strip comprised of a thin molding strip of flexible plastic with an undulating cross sectional configuration and states that the front face can be supplied with pre-finished wood grain or other decorative features. Similarly, U.S. Pat. No. 5,457,923 shows thin molding strips of flexible plastic which can be supplied with pre-finished wood grain or can be stained or painted. U.S. Pat. No. 4,274,237 shows a strip of trim inserted into a channel defined by parallel, opposing ledges. Similarly, U.S. Pat. Nos. 5,444,956 and 5,711,123 both show channels into which decorative materials such as cloth or plastic can be inserted.

U.S. Pat. No. 5,743,064 shows a protective wall railing having a decorative vinyl strip and discloses an extrusion system which can be used for making the wall rail with a decorative vinyl strip. The extrusion system uses pressure and temperature to bond the vinyl film to the thermoplastic sheet resulting in the vinyl film and thermoplastic sheet becoming one piece. This sheet, like the fabric or paper disclosed in other prior art, is then attached to the wall base. In the alternative, ink transfers onto solid or rigid support members are known in the art. A problem with the prior art is that the design is applied to the wall base not affixed nor integrated with it. Further, it is difficult to apply designs or decorations to wall bases, especially flexible wall bases, with complex profiles, particularly in a fast and economical process. Likewise, various decals are known for applying a sheet with a decorative design to the surface of a wall base. Seals, like other sheets or laminates applied to wall bases, are subject to being nicked or partially or entirely peeled off the surface of the wall base during use.

Heretofore, it was unknown to apply ink transfer to flexible plastic or rubber wall bases.

### SUMMARY OF THE INVENTION

The present invention provides a solution to the problems of the prior art with a method of manufacturing a surface decorated, flexible plastic or rubber wall base wherein decoration is easily affixed to a flexible plastic or rubber wall base by a heat transfer process. The invention has particular advantages for decorating wall and cove bases but it can be used for decorating other flexible plastic wall moldings, trim and flooring accessories as well.

In one form of the present invention, the cove base is extruded vinyl or rubber wall base which can be traditional straight cove bases, or coved, and prehung gauged cove bases such as TightLock® profile designs. TightLock® Wall Base is described in U.S. Pat. No. 5,212,923.

The wall base in its final form comprises a base layer and a printed surface decoration. The surface decoration or image is initially in the form of a foil or film which, according to the preferred embodiment of the invention, is transferred to the wall base layer in a dry, heat transfer process. Foils are available in metallic and pigment compositions. Foils come in a variety of matte and gloss-type finishes and consist of a wax release coat, a protective layer, a metallic or pigment layer that provides the decoration on the wall base surface and a sizing layer or layers made of resins, pigments, fillers, extenders, and plasticizers similar to those in the wall base formulation for compatibility. These layers are then attached to a carrier layer, typically made of clear polyester, which completes the foil ink transfer package.

During the process of manufacturing the finished wall base, a flexible plastic base layer is extruded and combined with a film or foil layer. To apply the foil to the flexible base layer, a heat transfer system comprising a pneumatic press, a transfer feeding device, a heat source, a die and a fixture to support or hold the article to be decorated, is used. In the art, there are four basic types of presses conventionally known for use in producing wall bases: vertical, conveyor roller, peripheral rolling stampers and rocker presses. The foil and the base layer pass through the heat transfer system in which ink from the foil is heat transferred to the base layer, creating a surface decorated wall base which, after passing through the heat transfer system, continues for additional cooling, cutting to length, and packaging, if required.

An object of the present invention is to provide a method for applying a decorative surface to an extruded plastic or rubber part.

Another object of this invention is to apply a decorative surface to a flexible wall base having a complex profile.

A further object of this invention is to provide a process for manufacturing a wall base with a complex profile and a decoration on its surface.

Yet another object of this invention is to provide a method for making wall base whose decoration is thermally bonded to the surface of the wall base.

Yet another object of this invention is to provide a method for applying ink transfers to a flexible, moving substrate.

It is still a further object to provide a variety of decorative surfaces to extruded plastic or rubber wall bases and the like, where the decorations can be intricate in design, and have a variety of finishes, including glossy, matte, metallic and the like.

Still another object is to provide a method for making wall base whose thermally bonded decoration can be applied in a cost efficient manner.

Yet a further object is to provide a flexible extruded plastic or rubber product, such as a wall base, having a complex profile with a transferred decorative surface design.

A still additional object is the provision of apparatus for transferring an ink design from a foil carrier to a flexible plastic or rubber strip having a complex profile.

These and other objects will become apparent from the following description of a preferred embodiment taken together with the accompanying drawings.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a front perspective view of a wall base;

FIG. 2 is an enlarged view of a wall base decorative foil;

FIG. 3 is a schematic view of a roller ink transfer press;

FIG. 3a is a cross-sectional view taken in the direction of the arrows A-A in FIG. 3; and

FIG. 4 is a schematic view of the apparatus for performing a manufacturing process according to a preferred embodiment of the invention.

### DETAILED DESCRIPTION OF THE PREFERRED EMBODIMENT

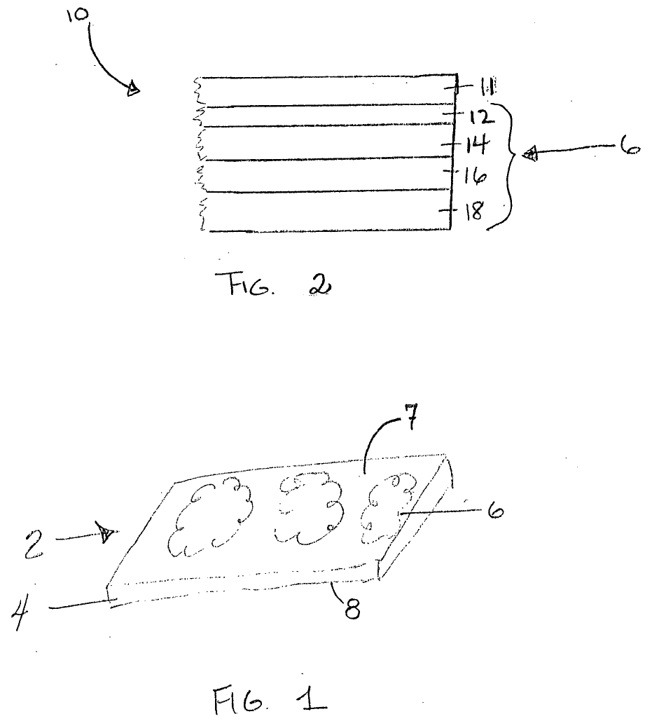

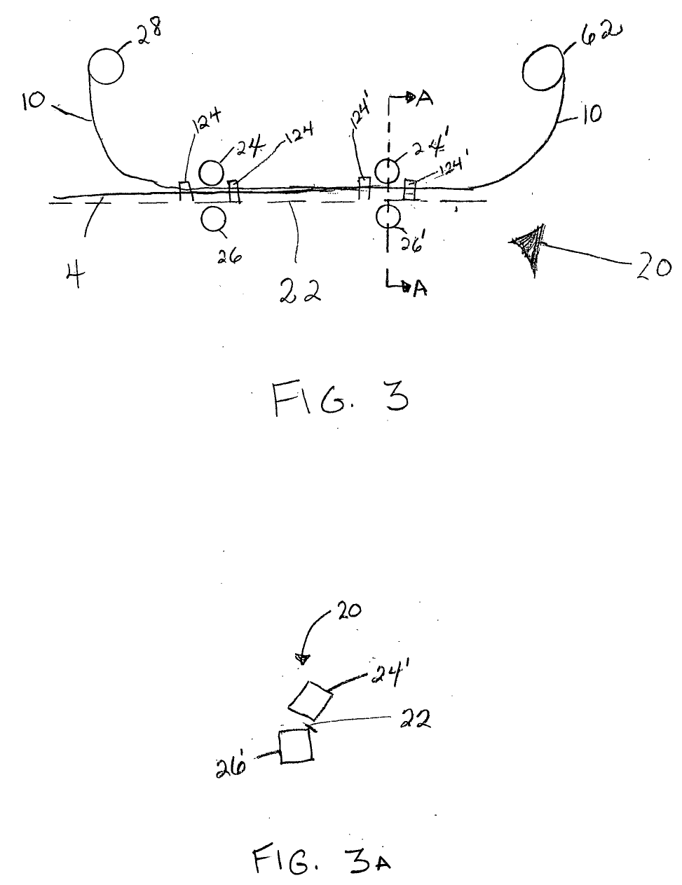

Referring now to the drawings wherein the showings are for the purpose of illustrating the preferred embodiment of the invention only, and not for the purpose of limiting same, FIG. 1 shows a wall base 2 which is composed of a flexible plastic or rubber base layer 4, and an ink transfer 6 containing a printed surface decoration or image. Base layer 4 can have a complex profile rather than a flat forward surface 7 parallel to a flat rearward surface 8. FIG. 2 depicts a foil or hot stamping film 10 from which ink transfer 6 was taken, and can be approximately 0.016″ to 0.019″ thick. One source for film 10 is CPS Resources Inc. of Charlotte, N.C. Ink transfer 6 comes in many colors, designs and patterns, such as wood, marble, granite, leaf and geometric, which can be transferred to wall base layer 4 in a dry, heat transfer process. Film 10 is composed of ink transfer 6 and carrier 11. Carrier 11, generally a plastic film often made of polyethylene, a very thin release layer, carries an optional protective layer, a color or printed image, and a sizing or adhesive layer or sticker. Each layer has its own chemistry and thus may be altered to suit the particular performance demands for either the application techniques and/or the end use requirements.

Foils are available in metallic and pigment compositions. Foils come in a variety of matte and gloss-type finishes and can be composed of generally seven or so layers, such as, for example, a release layer 12, a protective layer 14, a metallic or pigment layer 16 that provides the decoration on the wall base surface and one or more sizing layers 18 made of resins, pigments, fillers, extenders, and plasticizers similar to those in the wall base formulation for compatibility. These layers are attached to the carrier 11.

Most often carriers 11 are made from polyester films. Optionally, paper, coated with either plastic, wax or silicone, can also be used. Carrier materials can be chosen to provide gloss or no gloss; a choice can be made based on cost. Carrier materials as known in the art can be selected based on whether they are for top stamping, roller die or peripheral stamping. Generally a thickness from 0.5 millimeters (12 microns) to 1.2 millimeters (28 microns) will be used.

Release layers 12, which are applied directly onto the carrier 11, usually contain heat reactive or sensitive resins and/or waxes. During the transfer process, these layers are heated by the transfer roller(s) which softens and releases or breaks the bond between the carrier and the sub layers. Temperatures ranging from about 225° F. to about 450° F. (107° C. to 232° C.) are used to break the foregoing bond, and are contingent on the thickness of the heat ink transfer film to ensure proper transfer and adhesion to the substrate surface.

Protective layers 14, which ultimately end up as the outside surface of the finished decoration, play a very important role in the success of the heat transfer. These protective layers are varied to give scuff, chemical and UV resistance to the decoration. Generally speaking, the more functions that the heat transfer film performs, the thicker the protective layers must become, resulting in more difficulty during the application of the transfer. For example, heat transfer film of heavy appliance grade must be allowed to cool slightly before the label is stripped from the substrate after stamping because it has thick protective layers.

Pigment layer 16 is a broad generic classification of the layer that normally gives the look and/or the graphics one desires. Four-color process printing by rotogravure can yield near photographic picture quality as well as intricate patterns and designs. Opaque solid colors can be obtained by either the rotogravure process combining many tone variations of the same line colors or silk screening techniques combining just solid line colors. Gravure printing of blocks of color in discreet areas or parallel lines called “Zone Foils Transfers” permits the “one-hit” hot stamping of many colors with a single engraved die. Each printing process of the pigment layer has its particular advantages and disadvantages and gives the decorator a multitude of choices. This layer can also include an aluminum layer giving the reflectivity of imitation silver or gold, or it can be a very thick layer of pigment of almost any color imaginable. The finish can be glossy, matte, metallic, pearlescent, satiny or another finish as desired.

Sizing 18 or adhesive layer or sticker is formulated for compatibility with the plastic surface to be decorated. This layer may be as complicated as all the rest. Many of the above factors affect the choice of chemistry. Sometimes a bonding layer must be added between the pigment and sizing layers to prevent the splitting away of the pigments during decoration or subsequent product usage.

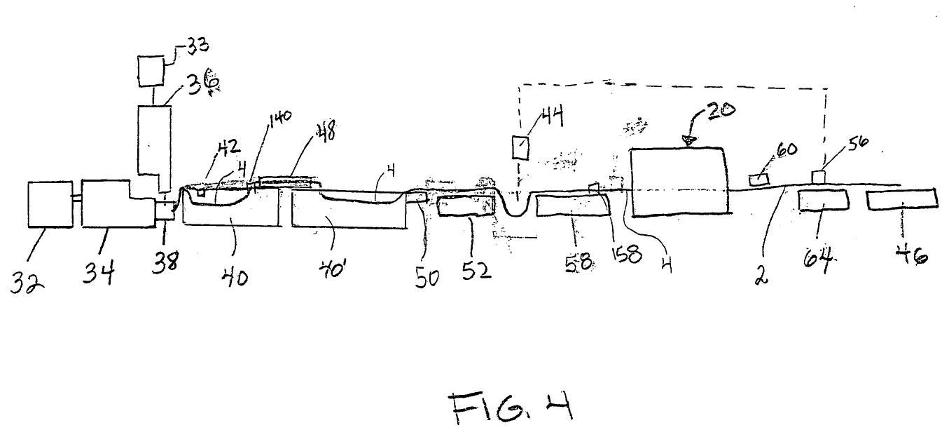

The image or decoration is transferred with heat and pressure using heated silicone rubber rollers mounted in standard equipment traditionally used in the industry for applying decorative coatings to elongated plastic surfaces, and modified for this application. This decoration can be applied to the wall base during the extrusion of the wall base profile or as part of a post extrusion process. Multiple rollers are utilized in the process and are designed to replicate and support the bottom and top sides of the wall base profile. In one embodiment of the inventive process, there are four rollers, located two abreast, three each having a diameter of about eight inches (20.3 centimeters) and the fourth being about three inches (7.6 centimeters), but other arrangements could be used as well. Generally the top rollers are silicone rubber heated by external radiant infrared heaters, such as those manufactured by Ogden of Arlington Heights, Ill. A non-contact temperature sensor measures the surface temperature of the moving rollers permitting a proper temperature controlled operation. Numerous types of conveyor roller machines having rollers in different positions and configurations exist. Conveyor rolling presses 20, as shown in FIGS. 3 and 3a, can be used as these machines can decorate large surface areas because the line of contact 22 that occurs among the rollers 24, 26, the ink transfer 6 and the base layer 4 reduces the tendency for the air to be trapped between the film 10 and the base layer 4 by providing continuous and controlled tension on the base layer and the ink transfer. The presses typically contain a foil feed or payout roller 28. The pressure between rollers 24 and 26, and 24′ and 26′ are pneumatically controlled. The top roller assembly is connected to an air cylinder and the amount of force placed by the top roller against the bottom roller is controlled by an air regulator or valve so that the amount of pressure exerted on the wall base and foil assembly can be increased or decreased by increasing and decreasing the air pressure.

The system according to a preferred embodiment shown in FIG. 4 includes a main extruder 34, pellet suppliers 32 and 33, a side extruder 36 and conveyor rolling press 20 through which the film 10 and base layer 4 pass. Main extruder 34 can be a 4½ inch Thermatic Davis Standard. The side extruder 36 can be a 2½ inch Mark V Davis Standard. The extruders 34, 36 feed into an extruder die 38 which can form a base layer 4 with various profiles such as a wedge-shaped base with a lip at the bottom, an undulating profile on a flat surface, or the like. The material emerging from extruder die 38 is a homogenous flowable mass of material. A first water bath 40, which, in a preferred embodiment, can be either a 30 foot (9 meter) or 40 foot (12 meter) trough, has at least one faucet 42; the bath, which can be on wheels enabling it to move towards and away from the extruder die 38, cools the extruded material. The bath has chilled water with a temperature range of 50° F. to 60° F. (10° C. to 16° C.), to cool the extruded flexible profile whose temperature upon entering the bath exceeds 300° F. (150° C.). The system also has at least one conveyor rolling press 20 including a dual head foil transfer with ultrasonic tension control 44, 56. This tension control or sensor can be a Versatec Tension Control which is a non-contact tension control which maintains payoff tension of the ink transfer film. The tension control essentially operates by proximity sensor. The proximity sensor monitors the diameter of the roll of ink transfer film and adjusts the payoff tension as the roll gets smaller. The resultant extruded profile emerges from a standard cutting station 46 which can be twelve feet (4 meters) long. In a preferred embodiment, the cutting station is six feet (2 meters) long and creates four-foot (1.2 meter) long wallboard. One example of such an extruded profile is shown in FIGS. 4 and 5 (front and back views) of U.S. Pat. No. 5,212,923.

The process used to create the flexible wall base can be as follows. Thermoplastic materials, such as PVC or thermoplastic rubber, along with pellets, granules or powder from the pellet supplier 32, are placed into either or both the main extruder 34 and/or the side extruder 36 which both feed into the extruder die 38. The extruder die yields an extruded base layer 4 with a temperature of at least 320° F. (180° C.) and the profile of the final product. From the extruder die 38, the base layer 4 is pulled into a first water bath 40. Next, the base layer passes through a cross-over tray 48 and into a second water bath 40′ with integral air blow-off station 50 which is preferably composed of upper and lower venturi blow off units for blowing water off the base layer 4. Then the base layer or extrusion passes through a variable speed first puller 52. The first puller 52 is maintained at a constant speed to ensure consistent size of the extruded profile as it is pulled from the extrusion die. The extruded profile then passes through a non-contact, ultrasonic speed controller 44 which controls the speed of the second puller 64 so as not to elongate or put undue stress on the extrusion while it is pulled through the heat transfer system 20. The non-contact ultrasonic speed controller 44 sends out an ultrasonic beam which is reflected back to the sensor of the speed controller 56 off the surface of the extruded profile 4. The ultrasonic speed controller maintains the extruded product at a set distance from the sensor head by increasing or decreasing the speed of the second puller 64.

First puller 52 preferably has caterpillar-type treads for engaging the flexible extrusion. The workflow has been efficiently done at from 38 to 40 feet per minute, and a workable speed is preferably from 38 to 50 feet per minute. The base layer next passes beneath a quartz pre-heater 58, having heating rods for raising the surface temperature of the base layer, preparing it to receive ink transfer 6 and removing any lingering moisture from the surface of the base layer 4. Guide bars 158 guide the extruded, heated flexible profile as it is pulled along under the heater. After the surface is heated and the moisture removed, the base layer 4 passes into the conveyor roller press 20, which includes dual head foil transfer rollers (24, 26, 24′, 26′ shown in FIG. 3) and a tension controlled ink transfer foil payoff 28 which supplies foil 10. In this press 20, the base layer 4 and the foil 10 are combined, forming a decorated, extruded wall base 2 using an in-line ink transfer process.

Inks from the foil 10 are applied to the base layer 4, transferred by heat from the heated top roller 24 and the pressure of rollers 24, 26 pushed together. The top roller 24 can be made of 60 to 70 durometer silicone rubber and the bottom roller 26 can be made of a harder rubber or aluminum; the rollers can be cut to match the contour of the wall base profile. The top roller 24 is heated to a temperature near the melting point of the base layer 4, i.e. to a temperature of about 300° F. (150° C.) for a base layer made of thermoplastic material. The foil 10 and base layer 4 are brought together by the top heated silicone roller 24 and bottom support roller 26 at a pressure of about 20 psi. Guide bars 124 guide the extruded, heated flexible profile as it passes between the rollers. The top heated silicone roller 24 and bottom support roller 26 make contact with the foil 10 and the base layer 4 simultaneously. During the dwell period (the length of time the rollers remain in contact with the foil and the wall base layer, determined by the line speed of the process which varies between 30 and 45 feet-per-minute depending on the profile), the heat of the silicone roller causes the release agents and the resins in the release layer 12 of the foil 10 to soften, and the pressure from the rollers helps the resins of ink transfer 6 to penetrate the heat-softened wall base layer 4 which promotes thermal bonding and transfer of the image or decoration to the surface of the wall base profile. The profile of the base layer 4 created in extrusion die 38 is followed by the configuration at the top and bottom rollers, so that the profile can be adhered to by the rollers 24, 26 and sufficient pressure can be applied to the ink transfer foil 10 and profile of base layer 4 by rollers 24, 26 to ensure proper transfer of the ink to the surface of the base layer.

The base layer 4 and foil 10 then may pass through another set of rollers 24′, 26′ or a roller assembly, similar or even identical to the first set of rollers but having the top roller 24′ tilted as shown in FIG. 3a to create pressure on a portion of the profile to which no pressure was applied by the prior roller assemblies, to ensure proper coverage of the ink transfer foil. As with the first roller assembly, guide bars 124′ guide the profile. Several roller assemblies, having top rollers tilted to varying degrees, may be required to transfer the ink to the surface of the wall base depending on the complexity of the wall base profile.

The wall base 2 emerges from the roller assemblies and the carrier layer 11 peels away from the wall base 2 and is coiled onto a take-up spool 62, with ink transfer 6 having been transferred to base layer 4. The surface decorated wall base profile 2 passes through an air-cooling system 60, and passes through a second puller 64 and then continues downstream in the process for cutting to length in the cutter station 46, and packaging, if required.

The present invention solves a prior problem of providing ink transfers to flexible moving workpieces made from plastic or rubber. It was heretofore impossible to make such transfers on at least a commercial basis because the flexible workpiece moved upon contact, a problem aggravated since the workpiece was heated. One important aspect of the present invention is the use of guide bars (bars 124 and 124′ for example) to provide constraints on the extruded workpiece. Another important aspect of the present invention is the ability to apply ink transfers to undulating profiles which is done by using more than one conveyor roller press 20 where each press is configured to press a distinct portion of the extruded profile. The constant speed and temperature controls also make important contributions to the present invention.

The invention has been described in detail with particular emphasis being placed on the preferred embodiments thereof, but variations and modifications within the spirit and scope of the invention may occur to those skilled in the art to which the invention pertains.

1. A method for making a decorated, extruded wall base, said method comprising the steps of:
extruding from an extruder die heated, flexible plastic or rubber extruded base layer having a profile;
passing said base layer through at least one chilling bath to cool the base layer;
removing water adhered to said base layer;
pulling said base layer by at least one variable speed puller from the extruder die, the speed of the puller being controlled according to the tension of said base layer;
providing a heat transfer film comprising a carrier layer carrying heat transfer layers including an ink transfer layer;
passing said base layer into a conveyor roller press having opposing top and bottom rollers, said base layer passing between said opposing top and bottom rollers;
passing said film into said conveyor roller press between said opposing top and bottom rollers, and heating at least one of said rollers to a temperature to enable the removal of the heat transfer layers from the carrier layer;
passing the heat transfer film between the top roller and a bottom roller;
applying pressure between the opposing rollers to apply pressure to the moving, flexible base layer and the moving heat transfer film moving between said rollers to transfer the heat transfer layers from the carrier layer to the base layer;
pulling the wall base through an air-cooling system by a second puller;
peeling the carrier layer from the heat transfer layers; and
withdrawing the decorated extruded wall base.

2. The method according to claim 1 further comprising repeating, at least once, the steps of bringing together, pushing together and adhering using additional top and bottom rollers.

3. The method according to claim 2, wherein at least one additional top roller is tilted to create pressure on a portion of the profile to which no pressure was applied by the prior top and bottom rollers and additional top and bottom rollers, said tilting for ensuring proper coverage of the ink transfer foil.

4. The method according to claim 1 wherein the temperature of said extruded base layer is at least 320° F. prior to passing through said first water bath.

5. The method according to claim 1 wherein said top roller is 60 to 70 durometer silicone rubber.

6. The method according to claim 1 wherein said bottom roller is aluminum.

7. The method according to claim 1 wherein said bottom roller is rubber.

8. The method according to claim 1 wherein said top roller and said bottom roller match the profile of the base layer.

9. The method according to claim 1, wherein said film layer is between 0.0159 inches and 0.0191 inches.

10. The method according to claim 1, wherein the temperature of said top roller is between 225° F. and 450° F.

11. The method according to claim 1, wherein said conveyor rolling press includes a dual head foil transfer with ultrasonic tension control.

12. A method for making a decorated, extruded wall base having a base layer and a film layer having a design layer and a carrier layer, the design layer being heat transferable from the carrier layer, said method comprising the steps of:
heating a top roller to a temperature beneath the melting point of the base layer;
bringing together the base layer and the film layer between said heated top roller and a bottom roller;
pushing together said rollers to apply pressure to the base layer and the film layer while said layers are between said rollers;
adhering, by heat from said heated top roller and by pressure from said pushed together top and bottom rollers, said design layer to said base layer;
pulling the wall base through an air-cooling system; and
peeling off the carrier layer from the film layer of the wall base.

13. A system for adding ink transfers to a movable flexible plastic or rubber strip, said system comprising:
a flexible plastic or rubber extruded base layer having a profile;
a heat transfer film having a carrier layer comprising heat transfer layers including an ink transfer layer;
at least one conveyor roller press, each press having opposing top and bottom rollers, at least one of said opposing rollers being heatable to a temperature to enable the removal of the heat transfer layers from the carrier layer; and
an air-cooling system, wherein:
the base layer and the heat transfer film pass between the opposing rollers of at least one press and the opposing rollers of the at least one press apply pressure to the base layer and the heat transfer film transferring the heat transfer layers from the carrier layer to the base layer, separating the carrier layer from the heat transfer layers and creating a wall base; and
the wall base passes through the air-cooling system.

14. A decorated, flexible wall base comprising:
a flexible, plastic base layer; and
a heat and pressure impregnated decoration in a surface of said base layer, said decoration including an ink transfer transferred from a foil and having predetermined color, design and pattern features.

15. A wall base according to claim 14, wherein said decoration is applied to said flexible, plastic base layer as said base layer moves through a heat and pressure conveying system in conjunction with a moving carrier having a removable ink transfer layer.
